(19) United States
(12) Patent Application Publication
(10) Pub. No.: US 2009/0257018 A1
(43) Pub. Date: Oct. 15, 2009

(54) Eyeglasses

(76) Inventors: Michael Shea, Manchester, NH (US); Riri Shea, Manchester, NH (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/102,061

(22) Filed: Apr. 14, 2008

(51) Int. Cl. G02C 7/16

(52) U.S. Cl. 351/45

(57) ABSTRACT

Disclosed is a pair of eyeglasses adapted to substantially block glaring light. The pair of eyeglasses includes a frame assembly and a pair of lenses supported by the frame. Each lens of the pair of lenses includes an opaque portion configured on an upper portion of each lens of the pair of lenses and a transparent portion configured on a lower portion of each lens of the pair of lenses. The opaque portion is adapted to substantially block light passing through the pair of lenses.

### FIELD OF THE INVENTION

The present invention relates generally to eyewear, and, more particularly, to a pair of eyeglasses capable of substantially blocking glare from a person's eyes.

### BACKGROUND OF THE INVENTION

People always find visibility problems while they move around in sunny days. For instance, a person such as a motorcyclist traveling around in a sunny day may not have a clear visibility due to a glare from a light, such as sunlight, that hits his or her eyes. Due to lack of clear visibility, the motorcyclist may not be able to see a path in which he/she is traveling, and thus the motorcyclist may meet with an accident.

Moreover, people involved in outdoor sports such as skiing may have the visibility problems during sunny days. Most skiers use goggles to cover their eyes while skiing. However, these goggles may not provide the clear visibility to the skiers due to the glare from the sunlight. Further, the goggles used by the skiers while skiing in extreme weather conditions may be subjected to frequent wear and tear.

Accordingly, there exists a need for a pair of eyeglasses which is capable of substantially blocking the light that may fall on the eyes of a person thereby providing a clear visibility to the person. Further, there exists a need for a pair of eyeglasses that is durable so as to withstand extreme weather conditions. Furthermore, there is a need of a pair of eyeglasses that is cost effective and aesthetically pleasing.

### SUMMARY OF THE INVENTION

In view of foregoing disadvantage inherent in the prior art, the general purpose of the present invention is to provide a pair of eyeglasses, to include all the advantages of the prior art, and overcome the drawbacks inherent therein.

An object of the present invention is to provide a pair of eyeglasses adapted to substantially block light passing through the pair of eyeglasses.

Another object of the present invention is to provide a pair of eyeglasses that is durable.

Yet another object of the present invention is to provide a pair of eyeglasses which is cost effective and aesthetically pleasing.

In light of the above objects, in one aspect of the present invention, a pair of eyeglasses is disclosed. The pair of eyeglasses includes a frame assembly and a pair of lenses supported by the frame. Each lens of the pair of lenses includes an opaque portion configured on an upper portion of each lens of the pair of lenses and a transparent portion configured on a lower portion of each lens of the pair of lenses. The opaque portion is adapted to substantially block light passing through the pair of lenses.

In another aspect of the present invention, the opaque portion may include an opaque film disposed on the upper portion of the pair of lenses of the pair of eyeglasses, such that the pair of eyeglasses is capable of substantially blocking the light passing through the pair of lenses.

In yet another aspect of the present invention, the opaque portion may include a paint film disposed on the upper portion of the pair of lenses of the pair of eyeglasses, such that the pair of eyeglasses is capable of substantially blocking the light passing through the pair of lenses.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of a pair of eyeglasses, in accordance with an exemplary embodiment of the present invention; and

FIG. 2 illustrates an exploded perspective view of the pair of eyeglasses of FIG. 1.

Like reference numerals refer to like parts throughout the description of several views of the drawings.

### DETAILED DESCRIPTION OF THE INVENTION

The exemplary embodiments described herein detail for illustrative purposes and are subject to many variations in structure and design. It should be emphasized, however, that the present invention is not limited to a pair of eyeglasses, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a pair of eyeglasses. The pair of eyeglasses is capable of substantially blocking light that may fall on eyes of a user. The term ‘light’ used herein referred to a glare from sunlight. The pair of eyeglasses precludes the eyes of the user from being exposed to the glare from the sunlight.

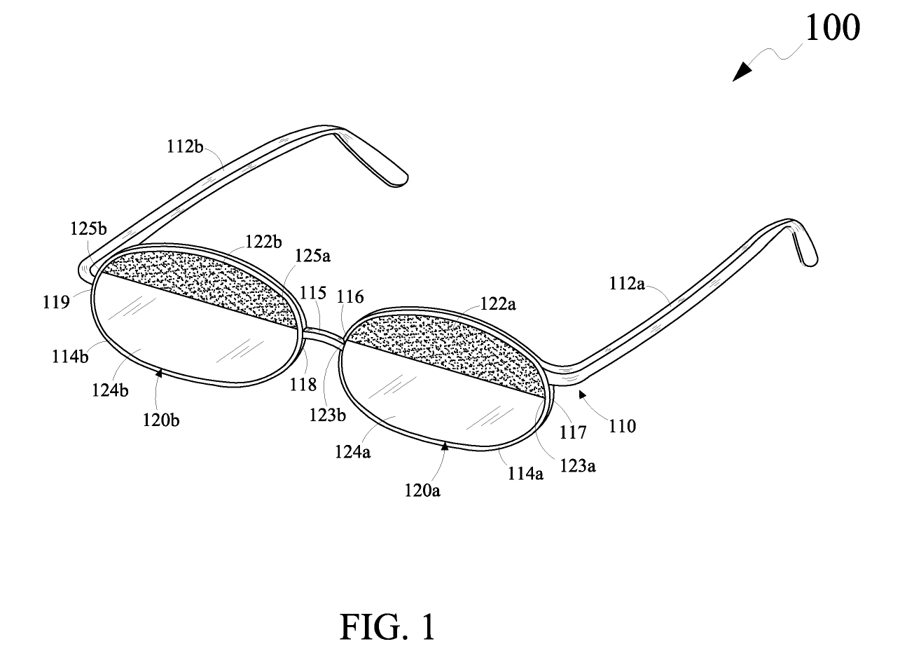

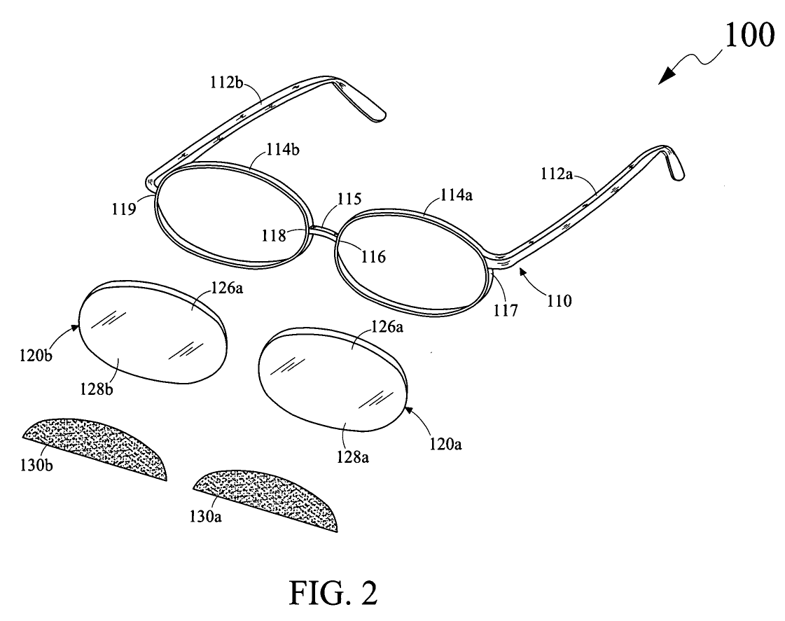

Referring to FIG. 1 and FIG. 2, a pair of eyeglasses 100 for blocking light from falling on eyes of a user is shown. More specifically, FIG. 1 illustrates a perspective view of the pair of eyeglasses 100 (hereinafter referred to as “the eyeglasses 100”), in accordance with an exemplary embodiment of the present invention. Further, FIG. 2 illustrates an exploded perspective view of the pair of eyeglasses of FIG. 1. The eyeglasses 100 include a frame assembly 110 and a pair of lenses, such as a lens 120a and a lens 120b. The lens 120a and the lens 120b are hereinafter collectively referred to as the lenses 120.

The frame assembly 110 includes a pair of arms, such as an arm 112a and an arm 112b, a pair of rims, such as a rim 114a and a rim 114b, and a nose piece 115. The rim 114a has a first end portion 116 and a second end portion 117. Further, the rim 114b has a first end portion 118 and a second end portion 119. The arm 112a is coupled to the second end portion 117 of the rim 114a. The arm 112b is coupled with the second end portion 119 of the rim 114b. Further, the nose piece 115 is coupled to the rim 114a and the rim 114b (hereinafter referred to as ‘the rims 114a and 114b) such that both ends of the nose piece 115 are coupled to the first end portion 116 and the first end portion 118 of the rims 114a and 114b, respectively.

The frame assembly 110 is configured to support the lenses 120. More specifically, the lenses 120 such as the lens 120a and the lens 120b are configured within the rims 114a and 114b, respectively such that the rims 114a and 114b support the lenses 120. In an embodiment of the present invention, the lenses 120 may be may be coupled with the arm 112a and the arm 112b (hereinafter referred to as “the arms 112a and 112b”) thereby configuring a rimless frame assembly. In such an instance, the lenses 120 may be supported by the arms 112a and 112b. It will be apparent to a person skilled in the art that the lenses 120 may be hingedly coupled with the arms 112a and 112b.

The lenses 120 include an opaque portion and a transparent portion. Specifically, the lens 120a includes an opaque portion 122a and a transparent portion 124a, and the lens 120b includes an opaque portion 122b and a transparent portion 124b.

The opaque portion 122a is configured on an upper portion 126a (see FIG. 2) of the lens 120a and the transparent portion 124a is configured on a lower portion of 128a the lens 120a. Similarly, the opaque portion 122b is configured on an upper portion 126b of the lens 120b and the transparent portion 124b is configured on a lower portion 128b of the lens 120b. The opaque portion 122a and opaque portion 122b hereinafter collectively referred to as opaque portions 122, and the transparent portion 124a and the transparent portion 124b are hereinafter collectively referred to as transparent portions 124. The opaque portions 122 are adapted to substantially block the light passing through the lenses 120, such that the eyes of the user is protected from the light. The transparent portions 124 are configured to enable the user to view through the lenses 120.

In an embodiment of the present invention, the opaque portions 122 may be configured by opaque films, such as an opaque film 130a and an opaque film 130b, as shown in FIG. 2. The opaque portion 122a includes the opaque film 130a disposed on the upper portion 126a of the lens 120a. Similarly, the opaque portion 122b includes the opaque film 130b disposed on the upper portion 126b of the lens 120b. In an embodiment of the present invention, the opaque film 130a and the opaque film 130b may be adhered to the upper portion 126a and the upper portion 126b, respectively using a glue. The opaque film 130a and the opaque film 130b are adapted to substantially block the light passing through the lenses 120 and thereby protecting the eyes of the user from the light.

In another embodiment of the present invention, the opaque portions 122 are configured by paint films. More specifically, the opaque portions 122 include paint films disposed on the upper portion 126a and the upper portion 126b of the lens 120a and the lens 120b. The paint films are configured by painting the upper portion 126a and the upper portion 126b with a paint material. The paint material is applied in a manner to make the upper portions 122 opaque. The paint films are adapted to substantially block the light passing through the lenses 120.

Further, in one embodiment of the present invention, the opaque portions 122 are configured on the lenses 120 in a manner such that the opaque portions 122 cover 30 percent of the lenses 120. However, it will be apparatent to a person skilled in the art that, the opaque portions 122 may be configured to cover any substantial portion of the lenses 120, which enables the opaque portions 122 to substantially block the light passing through the lenses 120.

In an embodiment of the present invention, the opaque films and paint films that configure the opaque portions 122 may be disposed on the side of the lenses that are proximate to the user's eyes. In another embodiment, the films may be disposed on side of the lenses that is distal to the user's eyes. In yet another embodiment, where the lenses 120 comprise laminate sections or a plurality of layers, the opaque and paint films may be disposed on at least one of the laminate sections or of the plurality of layers.

The pair of eyeglasses, explained in conjunction with FIGS. 1 and 2, may be advantageously used by a user to prevent light from falling on eyes of the user. The pair of eyeglasses is waterproof and durable and hence can be used by the user in extreme weather conditions. The pair of eyeglasses is a cost effective eyewear, since the opaque portions of the pair of eyeglasses may be configured in a cost effective manner. The pair of eyeglasses may be configured to have variety of sizes and designs, such that the pair of eyeglasses is aesthetically pleasing and may be worn by people of all age group. The pair of eyeglasses having variety of designs encourages users to express their individuality and style while complying with rules and safety standards. Additionally, the pair of eyeglasses may be efficiently used by a group of people which includes but not limited to motorcyclists, golfers, skiers, runners and any other outdoor sports enthusiasts.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

1. A pair of eyeglasses comprising:
a frame assembly; and
a pair of lenses supported by the frame assembly, each lens of the pair of lenses comprising an opaque portion configured on an upper portion of each lens of the pair of lenses, such that the opaque portion extends rectilinearly from a first end portion to a second end portion of each lens of the pair of lenses, the first end portion and the second end portion located opposite to each other, and a transparent portion configured on a lower portion of each lens of the pair of lenses, wherein the opaque portion is adapted to substantially block light passing through the pair of lenses.

2. The pair of eyeglasses of claim 1, wherein the opaque portion comprises an opaque film disposed on the upper portion of the each lens of the pair of lenses.

3. The pair of eyeglasses of claim 1, wherein the opaque portion comprises a paint film disposed on the upper portion of the each lens of the pair of lenses.
